(19) United States
(12) Patent Application Publication
(10) Pub. No.: US 2011/0056573 A1
(43) Pub. Date: Mar. 10, 2011

(54) PRESSURE REDUCING DEVICE OF A HIGH PRESSURE VESSEL

(76) Inventor: Mu-Sung HUANG, Taipei City (TW)

(21) Appl. No.: 12/556,150

(22) Filed: Sep. 9, 2009

(51) Int. Cl. G05D 16/04

(52) U.S. Cl. 137/505

(57) ABSTRACT

A pressure reducing device of a high pressure vessel includes primarily a housing, a gas guiding element and a gas directing element. The gas guiding element is defined with a first gas entraining passage, a second gas entraining passage, and a holding space into which a limiting element can be put and the gas directing element can be inserted. A contact surface of the gas directing element with the limiting element is formed with a gas seal part which is provided with an arc surface. Through sealing the arc surface with a groove on the limiting element, a gas seal effect can be improved and gas stability can be maintained for a long time.

### BACKGROUND OF THE INVENTION

a) Field of the Invention

The present invention relates to a pressure reducing device and more particularly to a pressure reducing device of a high pressure vessel which can increase a gas seal effect and maintain a long term stability of the gas.

b) Description of the Prior Art

Referring to FIG. 1, it shows a conventional gas seal structure of a high pressure gas cylinder, wherein a pressure reducing device 1 is composed primarily of a housing 10, a gas guiding element 12, a gas control kit 14 and a gas directing device 16. When high pressure gas in the high pressure gas cylinder 2 is to be outputted, the high pressure gas will pass through a gas passage 122 in the gas guiding element 12 and be expelled out through an exhaust hole 124 at the other end of the gas guiding element 12. When the high pressure gas cylinder 2 is filled with the high pressure gas, as a first elastic element 18 is not compressed, the gas directing device 16 will be at a normal position. As a result, a gas hole 160 which is formed at a pre-determined position on a wall of the gas directing device 16 will be connected with the exhaust hole 124 on the gas guiding element 12, enabling the high pressure gas to flow successfully to an emplacement chamber 162 of the gas directing device 16. At this time, the gas will result in a pressure to the gas directing device 16, enabling the gas directing device 16 to be compressed downward gradually. When the high pressure gas is filled to a pre-determined capacity, the gas directing device 16 will create a thrust to the first elastic element 18 and the gas hole 160 on the gas directing device 16 will be staggered with the exhaust hole 124 on the air guiding element 12 until that the high pressure gas is completely cut off. At this time, the high pressure gas will stop being outputted. To avoid the gas leaking out, the exhaust hole 124 on the gas guiding element 12 is provided with the gas control kit 14 having gas seal washers 140 and when the gas hole 160 is staggered with the exhaust hole 124, the gas seal washers 140 will be rubbing constantly with the hole following the staggering of the gas hole 160 with the exhaust hole 124, which will speed up wear-out of the gas seal washers 140 during operation. After the gas seal washers 140 have been used for a certain time, the wear-out is resulted as the gas seal washers 140 are unable to bear with the constant friction; therefore, an unstable condition will be formed in respect of gas pressure stability.

### SUMMARY OF THE INVENTION

The primary object of the present invention is to provide a pressure reducing device of a high pressure vessel which is assembled primarily by a housing, a gas guiding element and a gas directing element. The gas guiding element is defined with a first gas entraining passage, a second gas entraining passage, and a holding space into which a limiting element can be put and the gas directing element can be inserted. As a contact surface of the gas directing element with the limiting element is formed with a gas seal part which is provided with an arc surface, through sealing the arc surface with a groove on the limiting element, a gas seal effect can be improved and gas stability can be maintained for a long time.

Another object of the present invention is to provide a pressure reducing device of a high pressure vessel, wherein using gas seal washers which are located on the gas directing element and close to the gas seal part, stability can be achieved to balance the gas.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional gas seal structure of a high pressure gas cylinder.

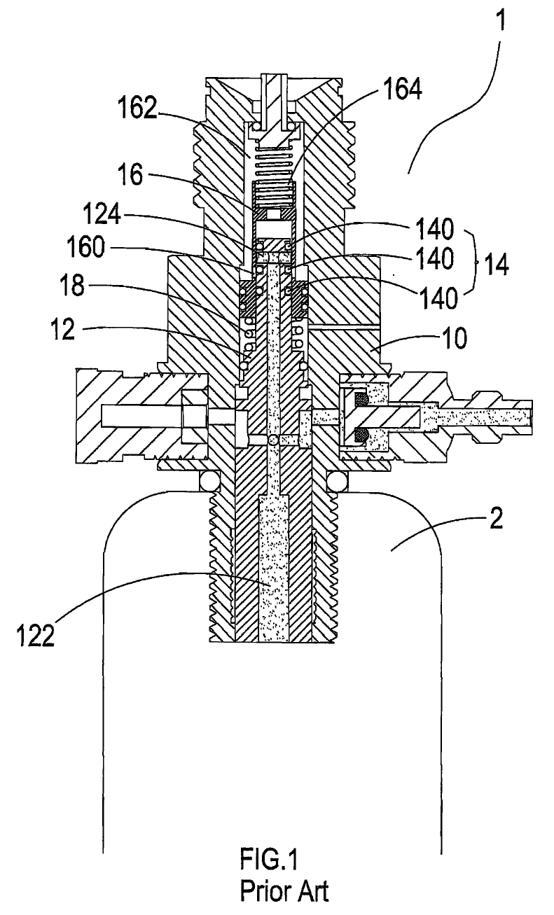

FIG. 2 shows a three-dimensional schematic view of a preferred embodiment of the present invention.

FIG. 3 shows a three-dimensional exploded view of a preferred embodiment of the present invention.

FIG. 4 shows a schematic view of an operation that high pressure gas is inputted and stored in a high pressure gas cylinder, according to the present invention.

FIG. 5 shows a schematic view of an operation that high pressure gas is outputted to a pressure reducing device, according to the present invention.

FIG. 6 shows a schematic view of an operation that high pressure gas enables a gas directing device to press down and to present a stand-by condition, according to the present invention.

FIG. 6A shows a local exploded view of a gas seal part and a limiting element of the present invention.

FIG. 7 shows a schematic view of an operation that a thimble is pushed to continuously fill with high pressure gas for output, according to the present invention.

### DETAILED DESCRIPTION OF THE PREFERRED EMBODIMENTS

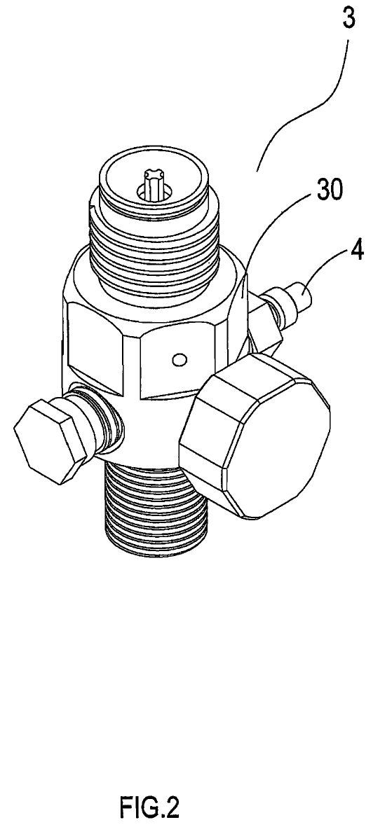

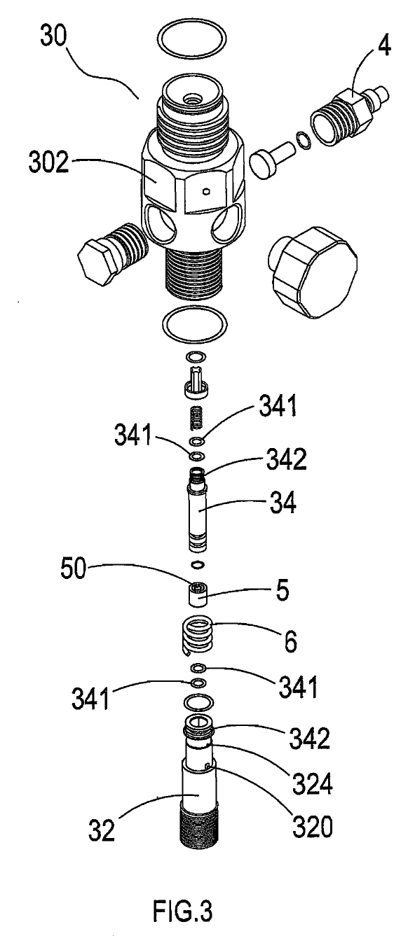

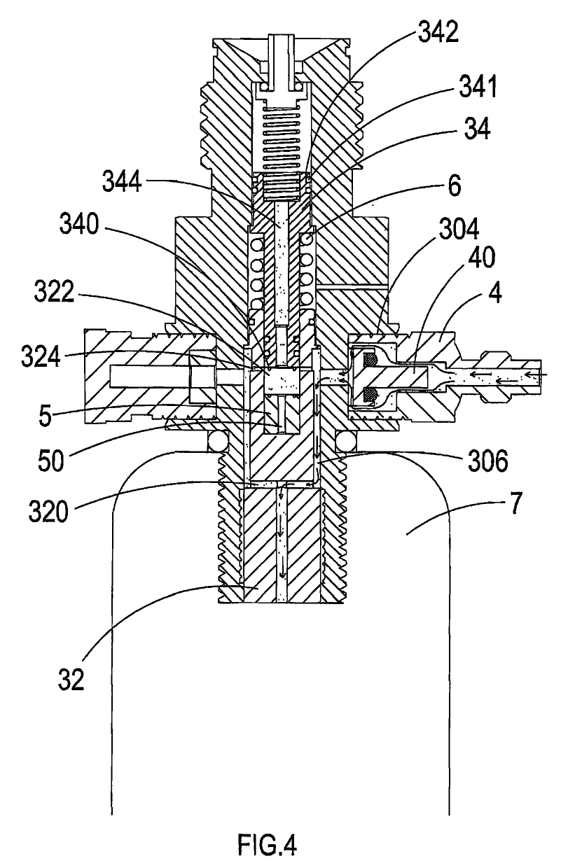

Referring to FIGS. 2 and 3, it shows a three-dimensional schematic view and a three-dimensional exploded view, of a preferred embodiment of the present invention. Referring to FIG. 4 at a same time, the present invention, as shown in the drawings, is a pressure reducing device of a high pressure vessel, wherein the pressure reducing device 3 comprises primarily a housing 30, a gas guiding element 32 and a gas directing element 34. A pre-determined position on a wall 302 of the housing 30 is defined with at least an emplacement chamber 304 to put a gas supply valve 4 and an interior of the housing 30 is formed with a channel 306 which is connected with the emplacement chamber 304. An interior of the channel 306 is provided with the gas guiding element 32 which is formed with a first gas entraining passage 320 by which gas from the gas supply valve 4 is guided to flow. In addition, a holding space 322 which is formed by the gas guiding element 32 is defined with a second gas entraining passage 324 and a bottom of the holding space 322 is provided with a limiting element 5 which is provided with a perforation 50. This holding space 322 also allows the gas directing element 34 to be inserted and the insertion end of the gas directing element 34 is formed with a gas seal part 340. On the other hand, two ends of the gas directing element 34 are formed respectively with at least two grooves 342 for sheathing with gas seal washer 341 and a gas passage 344 on the gas directing element 34 is connected with the holding space 322. The gas directing element 34 is sheathed and fixed with a first elastic element 6 which abuts the gas guiding element 32 to control the position of the second gas entraining passage 324 on the gas guiding element 32.

Referring to FIG. 4, it shows a schematic view of an operation that high pressure gas is inputted and stored in a high pressure gas cylinder, according to the present invention. As shown in the drawing, first, when a high pressure gas cylinder 7 is to be filled with gas, the gas can be inputted by using the gas supply valve 4. When filling the gas, as a piston module 40 in the gas supply valve 4 is pushed by the gas, the piston module 40 will be pushed off to form a space allowing the gas to flow. At this time, the gas will enter along the channel 306, pass through the first gas entraining passage 320 in the gas guiding element 32 and is stored in the high pressure gas cylinder 7.

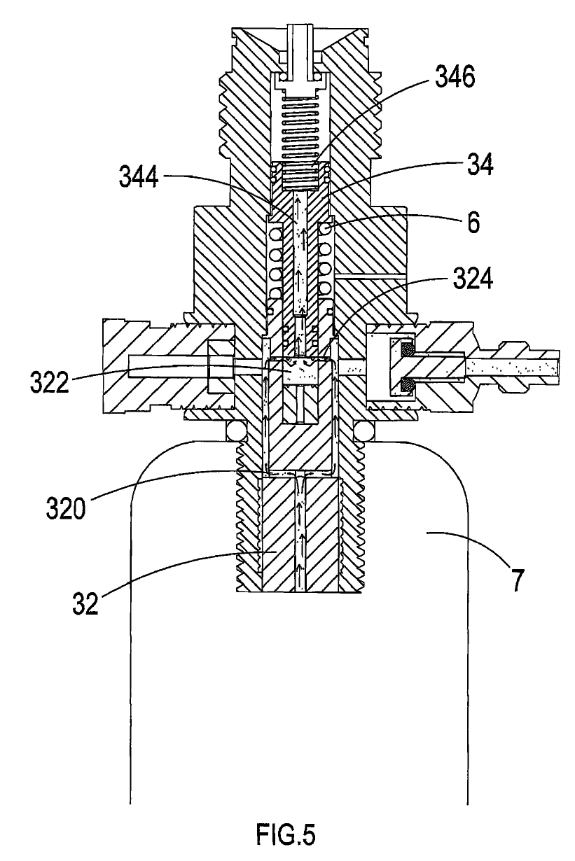

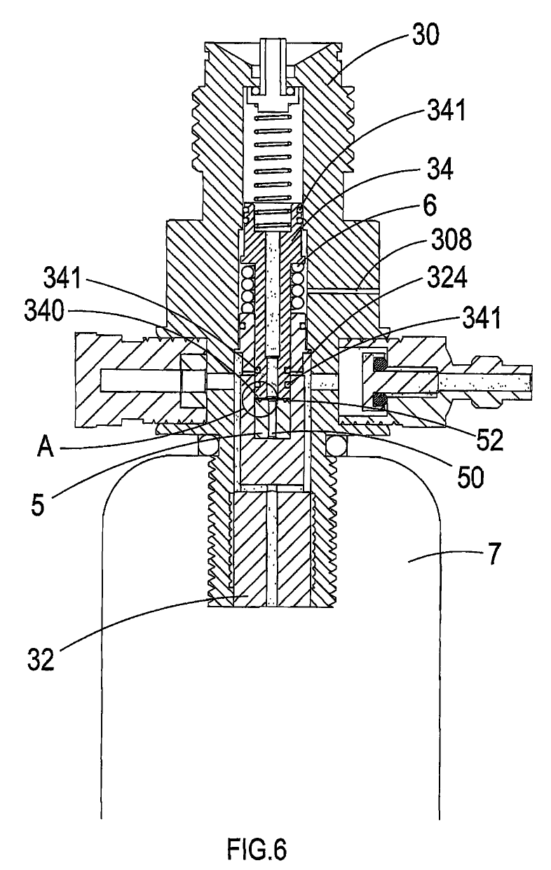

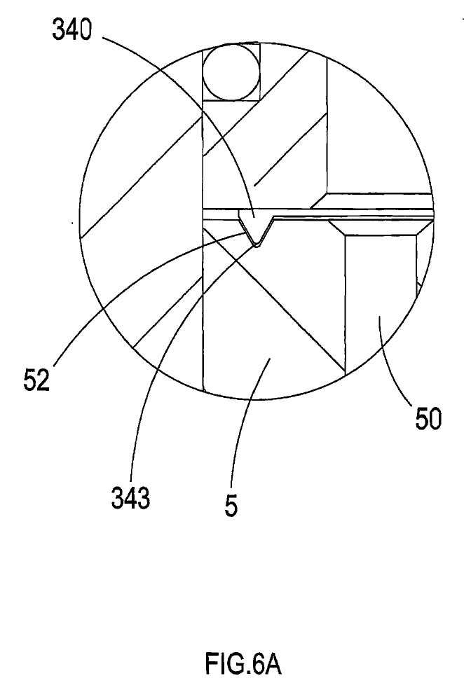

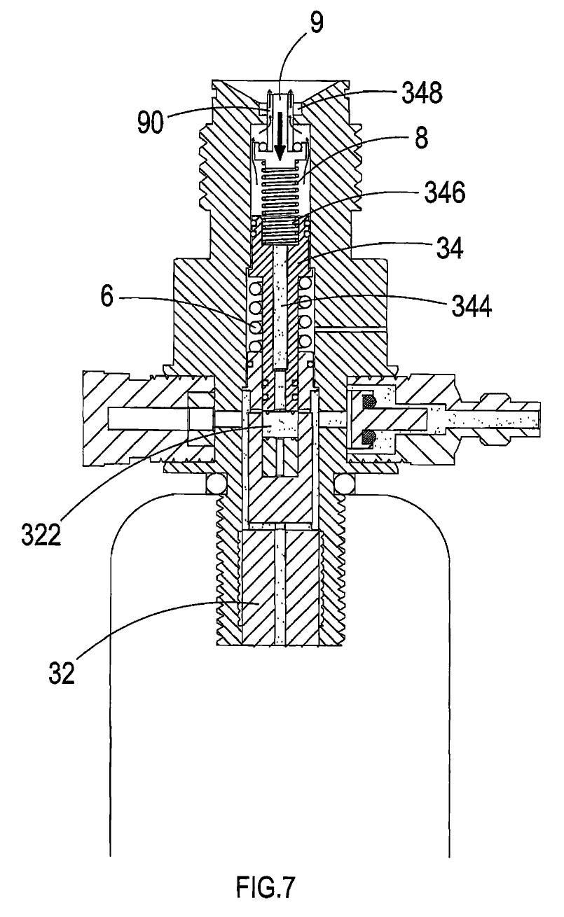

Referring to FIGS. 5, 6, 6A and 7, it shows a schematic view of an operation that high pressure gas is outputted to a pressure reducing device, a schematic view of an operation that high pressure gas enables a gas directing device to press down and to present a stand-by condition, a local exploded view of a gas seal part and a limiting element, and a schematic view of an operation that a thimble is pushed to continuously fill high pressure gas for output, according to the present invention. As shown in the drawings, when the high pressure gas in the high pressure gas cylinder 7 is to be outputted, the high pressure gas will pass through the first gas entraining passage 320 in the gas guiding element 32 and be expelled out through the second gas entraining passage 324 at the other end of the gas guiding element 32. When the high pressure gas is filled, as the first elastic element 6 is not compressed, the gas directing element 34 will be at a normal position. As a result, the gas passage 344 which is formed at the pre-determined position on the wall of the gas directing element 34 will be connected with the holding space 322 of the gas guiding element 32, allowing the high pressure gas to flow successfully to an emplacement chamber 346 which is formed by the gas directing element 34 (as shown in FIG. 5). At this time, the gas will create a pressure to the gas directing element 34, enabling the gas directing element 34 to be compressed downward gradually. When the high pressure gas is filled to a pre-determined capacity, the gas directing element 34 will create a thrust to the first elastic element 6 and the wall of the gas directing element 34 will be staggered with the second gas entraining passage 324 of the gas guiding element 32, until that the high pressure gas is completely cut off. At this time, the high pressure gas stops being outputted and the gas seal part 340 on the gas directing element 34 will be abutted with the limiting element 5. As the limiting element 5 is formed with a groove 52 and an arc surface 343, which is defined by the gas seal part 340, is abutted with the groove 52 to achieve a sealed state, the gas seal washers 341 which are provided close to the gas seal part 340 are able to increase a gas seal effect and can achieve a function of balancing the high pressure gas without affecting the gas after reducing the pressure, thereby achieving an effect of stabilizing an exhaust pressure. As the limiting element 5 is formed with the perforation 50, when the gas directing element 34 presses down, the object of balancing the gas can be achieved by a space in the perforation 50, such that the gas seal part 340 can really abut and seal the limiting element 5. Moreover, a circulating hole 308 which is formed on the housing 30 can be connected with a space of the first elastic element 6 to prevent from generating a vacuum pressure that a normal operation is unavailable (as shown in FIG. 6 and FIG. 6A). An end of the gas directing element 34 which is not inserted in the holding space 322 is defined with the emplacement chamber 346 to put a second elastic element 8, and the gas passage 344 of the gas directing element 34 is formed with a transfix part 348 which is inserted with a thimble 9, with an inner diameter of the transfix part 348 being closely adjacent to an outer diameter of the thimble 9. As the thimble 9 is abutted by the second elastic element 8, when the thimble 9 is squeezed by an external force to indent, the second elastic element 8 will be compressed. As a wall of the thimble 9 is circumferentially provided with plural grooves 90 for gas flow, the high pressure gas can be expelled out through these grooves 90. Therefore, the high pressure gas which is stored will decrease rapidly and at a same time when the high pressure gas decreases, the original pressure of the gas directing element 34 sustained by the high pressure gas will decrease gradually; whereas, the compression of the first elastic element 6 decreases correspondingly, allowing the first elastic element 6 to push the gas directing element 34. At this time, the gas passage 344 on the gas directing element 34 will be connected again with the holding space 322 of the gas guiding element 32 (as shown in FIG. 7). Meanwhile, as the pressure is reduced, the gas directing element 34 will move up gradually, such that the high pressure gas can pass through again to flow toward an area where there is little high pressure gas. Accordingly, by the aforementioned operation principle and method, the operation is executed repeatedly and continuously, which not only controls the gas pressure output condition and the high flow rate of the gas in the high pressure gas cylinder, but also maintains the high stability of the gas when operating in a long time.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A pressure reducing device of a high pressure vessel, comprising a housing, a pre-determined position on a wall of which is defined with at least an emplacement chamber for putting a gas supply valve, and an interior of which is formed with a channel connected with the emplacement chamber; a gas guiding element which is provided in the channel and includes a first gas entraining passage for guiding gas from the gas supply valve to flow, and a holding space having a second gas entraining passage; a limiting element which is provided at a bottom of the holding space and is transfixed with a perforation; a gas directing element, an end of which is formed with a gas seal part, an end of which having the gas seal part is inserted in the holding space, which is defined with a gas passage connected with the holding space, and two ends of which are formed respectively with at least two grooves sheathed with gas seal washers; and a first elastic element which is sheathed and fixed at the gas directing element and is abutted with the gas guiding element to control the position of the second gas entraining passage on the gas guiding element; accordingly, using a sealing function of the gas seal washers, the housing and the gas guiding element, a function of balancing the high pressure gas being achieved without affecting the gas after reducing the pressure, so as to achieve an effect of stabilizing an exhaust pressure.

2. The pressure reducing device of a high pressure vessel, according to claim 1, wherein the limiting element is formed with a groove.

3. The pressure reducing device of a high pressure vessel, according to claim 2, wherein the gas seal part is defined with an arc surface which abuts and seals the groove.

4. The pressure reducing device of a high pressure vessel, according to claim 1, wherein the housing further includes a transfix part which is inserted with a thimble and is formed at the gas passage of the gas directing element.

5. The pressure reducing device of a high pressure vessel, according to claim 4, wherein an inner diameter of the transfix part is closely adjacent to an outer diameter of the thimble.

6. The pressure reducing device of a high pressure vessel, according to claim 4, wherein a wall of the thimble is circumferentially provided with plural grooves for gas flow.

7. The pressure reducing device of a high pressure vessel, according to claim 1, wherein an end of the gas directing element which is not inserted in the holding space is defined with an emplacement chamber to put a second elastic element.

8. The pressure reducing device of a high pressure vessel, according to claim 7, wherein the other end of the second elastic element is connected with the thimble.

9. The pressure reducing device of a high pressure vessel, according to claim 1, wherein a wall of the housing is further formed with a circulating hole which is connected with a space where the first elastic element is held.
